(19) United States
(12) Patent Application Publication
(10) Pub. No.: US 2011/0174797 A1
(43) Pub. Date: Jul. 21, 2011

(54) CANTILEVER HEATING MECHANISM, AND A CANTILEVER HOLDER AND CANTILEVER HEATING METHOD THAT USE THE SAME

(75) Inventors: Masahiko Tomitori, Ishikawa (JP); Masato Hirade, Ishikawa (JP)

(73) Assignee: JAPAN ADVANCED INSTITUTE OF SCIENCE AND TECHNOLOGY, Nomi-shi, Ishikawa (JP)

(21) Appl. No.: 12/737,951

(22) PCT Filed: Sep. 4, 2009
(86) PCT No.: PCT/JP2009/065513

§ 371 Date: Mar. 31, 2011

(30) Foreign Application Priority Data
Sep. 5, 2008 (JP) 2008-228950

(51) Int. Cl. H05B 1/00

(52) U.S. Cl. 219/385

(57) ABSTRACT

A cantilever heating mechanism, and a cantilever holder and cantilever heating method that use the same, which make high-efficiency heating possible in air or in a high or low vacuum even for a general cantilever where no heating wiring pattern is provided, and further that enable localized heating and localized high-pressure/high-temperature treatment of specimens. Provided are a holder (1), which can detachably hold a cantilever (L) with a probe tip, and at least a first electrode (2a) and a second electrode (2b), which are in electric contact with the cantilever (L) held by the holder (1). The holder (1) is equipped with a stationary base (11) and a fixing part (12), which fulfills the function of an electrode.

### TECHNICAL FIELD

The present invention relates to a cantilever heating mechanism for heating a cantilever, and a cantilever holder used for scanning probe microscopy.

### BACKGROUND ART

Scanning probe microscopy (SPM) such as scanning tunneling microscopy (STM) and atomic force microscopy (AFM) is used for surface observation on an atomic and molecular scale as well as manipulation and assemble of atoms and molecules, and is expected to be used to fabricate nano-scale devices. SPM has been an essential method for nano-technology. SPM depicts images of surfaces using a physical probe tip that scans the specimen. In order to observe the specimen surfaces with atomic resolution, an atomically sharpened tip as the probe tip should be used with good sensitivity and reproducible detection of the physical exchange between the tip and a specimen. Thus, SPM requires the matter of a probe tip to be chemically stable and sharpened on an atomic scale, and it is desired to keep the probe tip clean, that is, not to be covered with foreign objects onto the probe tip.

For AFM using a cantilever to detect the force between a probe tip and the specimen, AFM cantilevers also are desired to be clean to improve the force sensitivity between the probe tip and the specimen, a probe tip made of silicon nitride or silicon is located at the end of the cantilever, and the cantilever is attached to a cantilever holder, and set the holder to a holder slot of the AFM. As a method of cleaning of the cantilever and the probe tip and sharpening of the tip, there are chemical methods using cleaning solution, sputtering methods to deposit the thin film, electron or ion beam irradiation methods, heating methods including radiant heat, indirect heat, and direct heat with passing current in it, and so on.

For example, the following Patent document 1 (JP Hei09-145726A) discloses a cleaning technique for the probe tip, using ultrasonic, cleaning solution, inert gas, the etching solution, sputtering, radiant heat. The following Patent document 2(JP Hei03-291501A) disclosed a cleaning technique to heat the probe tip made of metallic material by electrify. The probe tip is spot-welded to a metal wire loop, and a voltage is applied to two terminals of the loop to electrify into it. In addition, related art document 1 below, a commercially available conventional cantilever with a Si (silicon) tip for AFM was successfully modified to sharpen the tip by depositing Ge on it in ultrahigh vacuum and subsequently heating. This is the result by researchers including one of the inventors, the Ge deposited Si tip was confirmed to be remolded in the heating range of 400 degree C. to 500 degree C.

Recently, SPM is expectedly used not only for surface observation but also for micro-nano fabrication using interaction between a sharpened tip and a specimen surface. Thus, SPM is required to have the capabilities of local heating and high pressure processing to the specimen.

For example, Patent document 3 (JP Hei09-159680A), a heater is provided in a cantilever holder, which discloses a heating technique of the cantilever with a probe tip using a heater. The heater is a metal pattern formed on the cantilever holder, which is heated by electrify the metal pattern.

In addition, Patent document 4 (JP Hei10-27391A), a thin film resistor coil is provided to a cantilever to improve the efficiency of heat conduction, which discloses a technique of heating the probe tip.

### PATENT DOCUMENT

Patent document 1 is JP Hei09-145726A
Patent document 2 is JP Hei03-291501A
Patent document 3 is JP Hei09-159680A
Patent document 4 is JP Hei10-27391A

Literature

Related art document 1 is “Atomic force microscope Si tip with Ge clusters with the capability of remoulding by heating” Masahiko Tomitori et al., Nanotechnology Volume 18, Number 8, 28 February 2007, 084020

### DISCLOSURE OF THE INVENTION

### Problems the Invention intends to solve

The prior art mentioned above for the cleaning of cantilevers as well as for the sharpening of the probe tip, there are various techniques and the heating method is used as one of them. Particularly in Related art document, heat treatment is necessary. There are heating methods using indirect heat through thermal conduction from the heater by electrifying the wiring pattern formed on the cantilever, using radiation or using electron or ion beam irradiation.

Electron or ion beam irradiation method is used in a vacuum. However, electron or ion beam irradiation method is not conducted in an atmospheric or low atmospheric pressure. For example, the fifth embodiment in Patent document 1, disclosed a technique for cleaning a probe tip by ion beam irradiation to the tip. In this case, a vacuum chamber should be pumped down to a predetermined vacuum level.

The method using radiant heating and thermal conduction from the heaters, heating efficiency is poor. In addition, there can again be contaminated by outgas emitted from heated parts such as the cantilever heater. For example, the fourth embodiment in Patent document 1, disclosed a technique for heating a cantilever by the radiant heat from the cantilever heating furnace on a specimen base. In this case, the efficiency of radiant heat from the furnace is low and re-contamination due to outgas from heated parts is concerned.

For a typical electrifying heating method, a wiring heat pattern is formed on the cantilever. However, no commercially available cantilevers with the wiring heat pattern are provided. Thus, cantilevers widely used in the market of SPM can not be heated by electrifying. Patent document 2, disclosed a technique to heat a cantilever by electrifying a resistive conductor spot-welded to a probe tip. In general, however, this is not applicable to commercially available cantilevers with the probe tip, because it is difficult to weld them to the conductor. In particular, Si cantilevers with the probe tip are easily broken by spot-welding.

Patent documents 3 and 4 are also disclosed as techniques to heat cantilevers. However, the purpose of patent document 3 is to locally heat a small area of the specimen, and is not intended for cleaning. If this is applied to cleaning, the efficiency of heating is poor due to heat conduction from the heater, and the heater emits gases much, because the temperature of heater is the highest around the cantilever, leading to re-contamination of the probe tip and the cantilever. The purpose of the Patent document 4 is to form a small pit on a medium to record information using a heated cantilever, and is not intended for cleaning. If this is applied to cleaning, a special cantilever with a patterned thin film resistor is required; in general, this is not available commercially.

Particularly, by using the technique developed as related art 1 by the researchers including one of the inventors, the probe tip on commercially available conventional cantilevers can be remolded to be sharpened. To remold in the related art 1, it is necessary to heat them. Therefore, it is strongly required to establish the method to heat conventional cantilevers without wiring heat patterns.

As mentioned above, SPM is also used for micro-nano fabrication. Therefore, the method to heat a probe tip is also strongly demanded for the process of local heating of specimen with/without high pressure; a local pressure can be applied with the tip in a controlled manner using AFM.

In view of the above, the object of the present invention is to provide a cantilever heating mechanism for heating general cantilevers, and a cantilever holder comprising the cantilever heating mechanism, and a cantilever heating method for heating general cantilevers, that is available to heat at high efficiency in an atmosphere, low vacuum, high and ultra-high vacuum, without wiring patterns for heating.

### SUMMARY OF THE INVENTION

To accomplish the above object, the present invention provides a cantilever heating mechanism for heating a cantilever with a probe tip, comprising: a holder which detachably holds the cantilever; and at least a first electrode and a second electrode, which are in electric contact the cantilever by holding the cantilever onto the holder. According to the present invention, a conductive (or semiconductive) cantilever attaches to the holder, and a voltage is applied between the first electrode and the second electrode, which are in electric contact by holding the cantilever onto the holder, and the cantilever is heated by electrifying it.

The present invention, further comprising a third electrode is preferably. According to the invention, control of the potential of the third electrode with respect to those of the first and the second electrodes can collect electrons or holes near the first and second electrodes. In this case, a controller is equipped, wherein the controller controls the potentials of the first electrode and the second electrode and/or the controller controls that of the third electrode; this is preferably for easy to perform electrifying heat.

A cantilever heating mechanism according to the invention, wherein the holder is equipped with a stationary base and a fixing part, and the cantilever is pushed and held to the stationary base by the fixing part, wherein the first electrode and the second electrode are preferably arranged on the stationary base for holding the cantilever. According to the invention, the cantilever is arranged to the stationary base and fixed onto the base by the fixing part; the cantilever is pushed and held to the stationary base with the fixing part as a spring, and the cantilever is connected with the first electrode and the second electrode certainly on the base.

A cantilever heating mechanism according to the invention, wherein the holder is equipped with a stationary base and a fixing part, and the cantilever is pushed and held to the stationary base by the fixing part, which is preferably conductive material. According to the invention, the stationary base is at least equipped with the first electrode and the second electrode, and the fixing part can be used as the third electrode.

The cantilever holder is preferably used for scanning probe microscopy (SPM). According to the invention, the cantilever can be heated in the state of fixing the cantilever to the cantilever holder of SPM.

The present invention of a cantilever heating method for heating a cantilever with a probe tip, comprising steps: holding the cantilever onto a holder which detachably holds the cantilever; and applying a voltage at least between a first electrode and a second electrode, which are in electric contact with the cantilever by holding the cantilever onto the holder. According to the present invention, the cantilever is held onto the holder, and the cantilever is heated by electrifying heat with applying a voltage between the first electrode and the second electrode.

The present invention further comprising steps: attaching a third electrode to the cantilever, which is in electric contact by holding the cantilever onto the holder; and preferably controlling the potential of the third electrode with respect to those of the first and the second electrode. According to the invention, control of the potential of the third electrode with respect to those of the first and the second electrodes can collect electrons or holes near the first electrode and second electrode.

### Effects of the Invention

According to the present invention of a cantilever heating mechanism, the cantilever attaches to the holder, and a voltage is applied between the first electrode and the second electrode, which are in electric contact by holding the cantilever onto the holder, and the cantilever is heated by electrifying. And according to the present invention of a cantilever heating method, the cantilever is held by the holder, and the cantilever is heated by electrifying heat with applying a voltage between the first electrode and the second electrode. Therefore, general cantilevers are available to be heated at high efficiency without wiring patterns for the heating. And they can be cleaned and re-modified to sharpen their probe tips. A vacuum is not necessary for this method, while it is required for methods such as an electron or ion beam irradiation method. The invention is available to heat at high efficiency in an atmosphere, low vacuum, high and ultrahigh vacuum without wiring patterns for the heating. The invention comprises to electrify the cantilever directly so that heating efficiency of the invention is much better than using the heater or indirect heating. Moreover, control of the potential of the third electrode with respect to those of the first and the second electrodes can collect electrons or holes near the first electrode and second electrode, so that the heating efficiency near the cantilever is higher. The cantilever heating mechanism is applied to a cantilever holder of SPM, which is available to reach local high temperature heating and high pressure for nano-micro fabrication.

### BRIEF DESCRIPTION OF THE DRAWINGS

FIG. 1 is an exploded perspective view illustration of the first embodiment cantilever heating mechanism.

FIG. 2 is an expanded perspective view illustration of a part of the first embodiment cantilever heating mechanism.

FIG. 3 is a using condition of perspective view illustration of the first embodiment cantilever heating mechanism.

FIG. 4 is a circuit illustration of the first embodiment cantilever heating mechanism.

FIG. 5 is a top view illustration of an invention cantilever holder using the first embodiment cantilever heating mechanism.

FIG. 6 is a graph result of experiment 1, before and after the heating of the first embodiment cantilever heating mechanism, and cantilever resonance curves at each heating temperature.

FIG. 7 is a graph, result of the experiment 1, compared Q values with the cantilever resonance curves according to the first embodiment cantilever heating mechanism.

FIG. 8 is a graph result of experiment 2, indicates temperature of each heat to the cantilever when the cantilever is electrified to be heated using the first embodiment cantilever heating mechanism.

### DETAILED DESCRIPTION OF THE INVENTION

Next, the description will be made concerning concrete embodiment cantilever heating mechanism 100 according to the present invention by referring to the drawings.

### First Embodiment

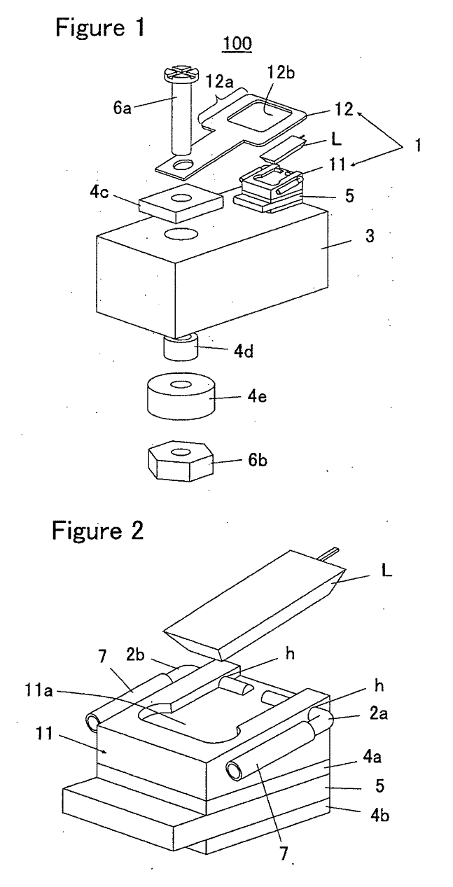

According to the embodiment cantilever heating mechanism 100, FIG. 1 is an exploded perspective view illustration, and FIG. 2 is an expanded perspective view illustration of a part of the first embodiment cantilever heating mechanism 100. The cantilever heating mechanism 100 comprising: a holder 1 holding the cantilever L which is detachably held onto the holder, and a first electrode 2a and a second electrode 2b, which are in electric contact by holding the cantilever L onto the holder 1, and a third electrode 12 functions that acts as a fixing part. These electrodes 2a, 2b, 12 are arranged on base 3. The cantilever L is made of semiconducting material such as Si (silicon), and the cantilever L is fixed onto the electrode 2a and 2b by one end of the spring plate of the electrode 12.

The holder 1 comprising: a stationary base 11 for fixing the cantilever L, and a fixing part 12 for fixing the cantilever L to the stationary base 11. The stationary base 11 is a high melting point material with superior electrical insulation. The stationary base 11 is a ceramics, alumina, for example. It is not limited to them, and high melting point and insulating materials are also good. And a concave placement 11a for holding the cantilever L is formed to the stationary base 11. Between the stationary base 11 and the base 3, a piezoelectric element 5 is inserted between the insulation parts 4a, 4b.

The third electrode 12 functions as that fixing part 12 for fixing the cantilever L to the stationary base 11. As the embodiment, the fixing part 12 is a leaf spring that pressing for the cantilever L direction to hold the stationary base 11. The fixing part 12 is a conducting material with high melting point such as molybdenum. One end of the fixing part 12 is fixed at base 3 by a screw 6a. More specifically, the screw 6a is inserted into a hole provided on one side of the fixing part 12, and the screw 6a is fixed by a nut 6b behind the base 3. The other end of the fixing part 12 is as a free end, and it is extended to the concave placement 11a of base 11, and a free portion 12a pressing the cantilever L. The portion 12a is formed wide and comprises an opening 12b in the center. Opening 12b formed in the center of the portion 12a makes a small contact area between the cantilever L and the fixing part 12, so that the cantilever L can be heated high-efficiently. In addition, the end of the fixed part 12 pushing a center of the cantilever L. So, the cantilever L strongly contacts to the concave placement IIa and the electrodes 2a, 2b. Also, the configuration of the embodiment can easily remove the cantilever L. Between the fixing part 12 and the base 3 is arranged the insulator 4c, and between screw 6a and base 3 is arranged the insulator 4d, and between nut 6b and base 3 is arranged the insulator 4e. So, the fixing part 12 and the base 3 are electrically insulated from each other.

The electrodes 2a, 2b, 12 are electrical connectable to the cantilever L held by the holder 1. According to the embodiment, the electrodes 2a, 2b are arranged to the concave placement 11a as portions of base 11, and the electrode 12 is the conductive fixing part 12. A pair of the first electrode 2a and the second electrode 2b, which are in electric contact with the cantilever L held by the holder 1, and the cantilever L is electrified to be heated. The third electrode 12 as a conductive fixing part is for controlling the condition of the electrifying heat as well as the electrodes 2a, 2b. The electrodes 2a, 2b are arranged nearby the cantilever when the cantilever L is pushed and held to the concave placement 11a by the fixing part 12. The electrodes 2a, 2b are conducting material with high melting point such as tungsten. The electrodes 2a, 2b are elongated electrodes and 0.3 mm diameter metal wire electrodes are used. Holes h, h are formed from both outsides of the base 11 to insides at the arrange portion 11a. And both electrodes 2a, 2b are inserted into each of the holes h, h and fixed to the base 11 firmly. Each one end of electrodes 2a, 2b are protruded to the arrange portion 11a, and each other end of the electrodes 2a, 2b are protruded to outsides of the base 11. A pair of pipes (copper pipe) 7, 7 are arranged to each the other end of electrodes 2a, 2b. The electrodes 2a, 2b are electrical connectable to power supply p1 (not shown in FIG. 2) by wiring of the pipes (copper pipe) 7, 7. The fixing part 12 is electrical connectable to power supply p2 (not shown in FIG. 2) by wiring. The fixing part 12 is electrical connectable to power supply p2 (not shown in FIG. 2) by wiring of screw 6a, is also good.

### Using Condition

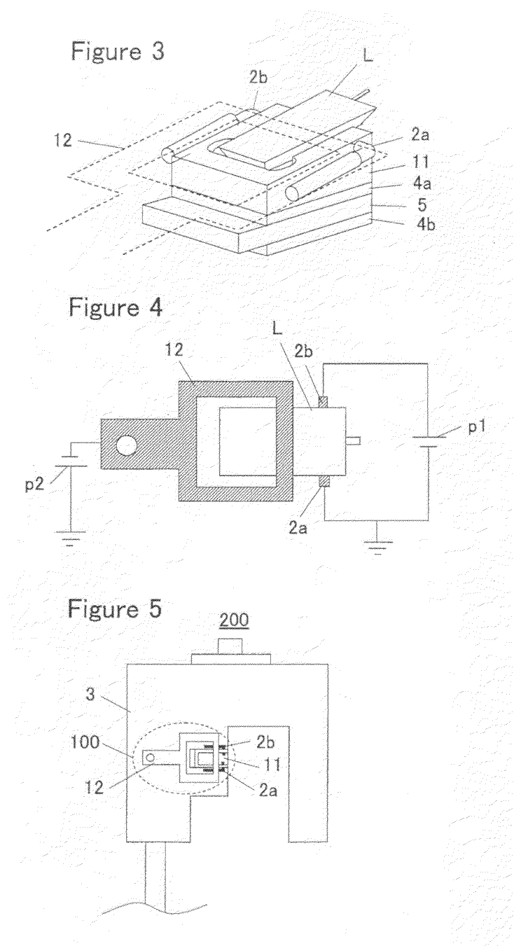

According to the embodiment cantilever heating mechanism 100, FIG. 3 is a using condition of perspective view illustration. In FIG. 3, the fixing part 12 is shown dotted lines for showing location of it. Procedure to arrange the cantilever L: up the fixing part 12 as the leaf spring, and arrange the cantilever L to the arrange portion 11a of the base 11. The cantilever L is on the protruded parts of the electrodes 2a, 2b at the arrange portion 11a. At this condition of the cantilever L, release the fixing part 12, then the fixing part 12 pushes the cantilever L to the base 11 by urging force of leaf spring pressure (spring). Therefore, the cantilever L is held onto the base 11, and the cantilever L is electrical connected with the electrodes 2a, 2b, 12. So, the cantilever L is in a state where three independent electrodes are arranged.

The cantilever L is fixed to the base 11 by pressing force of the fixing part 12, so that the cantilever L is electrical connected with the electrodes 2a, 2b certainly, and electrical connection is guaranteed.

According to the embodiment cantilever heating mechanism 100, FIG. 4 is a circuit illustration. The electrodes 2a, 2b are electrical connected to variable power supply p1 by wiring. The fixing part 12 is electrical connected to variable power supply p2 by wiring. Ground line is connected each circuit. The power supply p1, p2 are controlled ON/Off and supply voltages preferably.

On the condition, a voltage is supplied between the electrodes 2a, 2b, and the electrodes 2a and 2b are electrical connected with the cantilever L, then the cantilever L is electrified to be heated. The embodiment further comprising: a controller, wherein the controller controls the variable power supply p1 for control of potentials of the electrode 2a, 2b, or wherein the controller controls the variable power supply p1 and p2 for control of potentials of the electrode 2a, 2b and 12. For electrifying heat, the potential of the third electrode 12 potential is controlled with respect to the potentials of the first electrode 2a and the second electrode 2b. The cantilever L is made of semiconducting material such silicon. For example, the controller controls the positive output of variable power supply p1 with respect to the ground and the negative output of variable power supply p2 with respect to ground. Thus, it can collect electrons at contact place between the cantilever L and the electrode 2a or 2b accordingly to the output of variable power supply p2, or it can collect electrons at straddling region of the electrodes 2a, 2b accordingly to the output of variable power supply p2. For example, the controller controls the negative output of variable power supply p1 with respect to ground and the positive output of variable power supply p2 with respect to ground. Thus, it can collect holes at contact place between the cantilever L and the electrode 2a or 2b accordingly to the output of variable power supply p2, or it can collect holes at straddling region of the electrodes 2a, 2b accordingly to the output of variable power supply p2. Therefore, the electrifying heat current is concentrated near the cantilever with a tip, so that the tip is heated at high efficiency. It is also applicable that the controller can control only the potentials of electrode 2a, 2b or the potential of electrode 12.

According to the embodiment, general cantilevers are available to be heated at high efficiency without wiring patterns for the heating. And it can be clean and re-modified to sharpen their probe tips. A vacuum is not necessary, while it is desired for methods such as an electron or ion beam irradiation method. The invention is available to heat at high efficiency in an atmosphere, and low, high and ultrahigh vacuum without wiring patterns for the heating. The invention uses electrifying the cantilever directly so that heating efficiency of the invention is much better than using the heater or indirect heating. Moreover, contamination due to outgas emission is very few.

According to the embodiment cantilever heating mechanism 100, it can be use as a unit, and it is preferably applied to a cantilever holder of SPM such as AFM. FIG. 5 is a top view illustration of an invention cantilever holder 200 using the first embodiment cantilever heating mechanism 100. Incidentally, the elements of the present embodiment that are the same as those in the previous embodiment are given with the same reference numerals or symbols, and the description thereof will be omitted. The cantilever holder 200 is used generally, and it is inserted at a holder slot of SPM, and is used in a place. U-shaped body 3 of the cantilever holder 200 corresponds to the base 3 of the cantilever heating mechanism 100. The electrodes 2a, 2b, 12 are electrical connected to variable power supplies which are placed outside of SPM by wiring (not shown in Figures). Thus, the cantilever L is useable with attaching to the cantilever holder 200, and inserted in SPM. By applying voltage to the electrodes 2a, 2b, heating the cantilever L, and bringing the cantilever L close to a specimen, the specimen is heated locally. Moreover, by bringing the tip of the cantilever L in contact with the specimen, local high temperature heating and high pressure process is conducted, which is widely applicable to micro-nano fabrication as well as observation in a special environment.

Particularly, by using the cantilever heating mechanism 100, the probe tip of a commercially available cantilever is preferably to be re-modified to be sharpened. As described, developed by the researchers including one of the inventors, a commercially available cantilever with a Si (silicon) tip was successfully modified to be sharpening by depositing Ge on it in ultrahigh vacuum and subsequently heating. The Ge deposited Si probe was confirmed to be remolded in the heating range of 400 degree C. to 500 degree C. The heating range of 400 degree C. to 500 degree C. is much lower than melting point of Si, so that the cantilever is not damaged by the heating. Using the cantilever heating mechanism 100, which is available to heat at high efficiency without wiring patterns for the heating, the method of re-modifying to sharpen the probe tips of commercially available cantilevers is widely applied. Using the cantilever holder 200 that comprising the cantilever heating mechanism 100, cantilever L with a Si (silicon) tip is successfully modified to be sharpened by depositing Ge on it with no risk of damage.

### Experiment 1

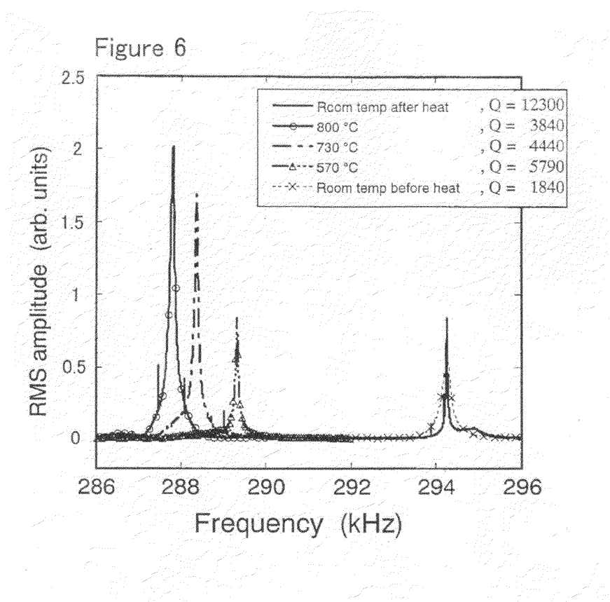

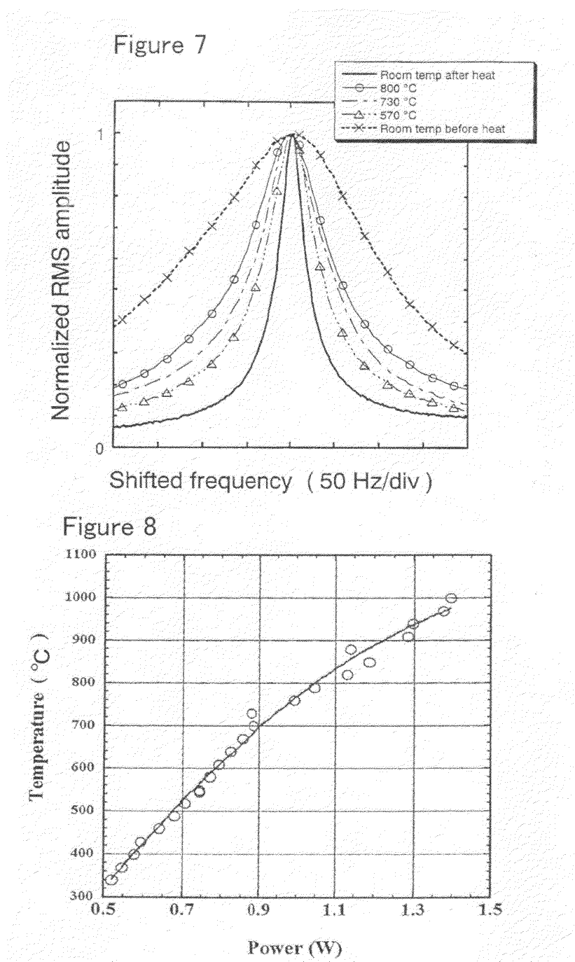

To determine the effect of the present invention, the following experiment 1 was conducted using the cantilever heating mechanism 100. Under vacuum environment, the first electrode 2a and the second electrode 2b were electrical connected to variable power supply p1, and the current value from the variable power supply p1 was changed step by step. The resonant frequency and Q value at each temperature were measured. The variable power supply p2 was not used. FIGS. 6 and 7 show the results. FIG. 6 is a graph result of experiment 1 before and after the heating of the first embodiment cantilever heating mechanism, and cantilever resonance curves at each temperature. Horizontal axis is frequency and vertical axis is RMS (root mean square) amplitude. FIG. 7 is a graph result of the experiment 1, showing the change in Q value with heating temperature by normalizing curves in FIG. 6. Q value before the heating was 1840, and Q value after heating was 12300. This change in Q value indicates the increase in detection sensitivity of force between the tip and the specimen, given by the invention.

### Experiment 2

To determine heating effect of the present invention, the following experiment 2 was conducted using the cantilever heating mechanism 100. Under vacuum environment, the first electrode 2a and the second electrode 2b were electrical connected to variable power supply p1, with changing output current from the variable power supply p1 step by step, the temperature was measured using a thermometer. Electrifying current was changed in the range of 65 mA to 225 mA, corresponding supply voltage of 8V to 6.2 V; the input power ranged of 0.52 W to 1.395 W. FIGS. 8 shows the result. At an input power of 1.395-W the temperature reached about 1000 degree C. This means that the cantilever holder is applied to SPM with capabilities of processing specimen heated locally at high temperature. It is preferably used not only for cleaning the probe tip and the cantilever at high temperature, but also for micro-nano fabrication process at the surface of specimen by the invention.

Furthermore, the present invention is not limitative as above embodiment. The invention comprising: a holder which detachably holds the cantilever; and at least a first electrode and a second electrode. The holder is not limitative as above embodiment, which detachably holds the cantilever. In addition, the electrodes 2a, 2b and 12, that spring plate or spring wire arranges, i.e., four or more electrodes can be electrically connected to the cantilever. And arranged positions are changeable on design. The stationary base can be made of non-conductive material. In this case, other electrodes can be used for electrifying heat. The stationary base can include the first electrode or second electrode. The cantilever holder is applied to SPM, and it is not limitative as AFM. Moreover, the present invention can appropriately be modified within the objects of the present invention.

1.-8. (canceled)

9. A cantilever heating mechanism for heating a cantilever with a probe tip, comprising:
a holder which detachably holds the cantilever; and at least a first electrode and a second electrode, which are in electric contact with the cantilever by holding the cantilever onto the holder, and a voltage is applied between the first electrode and the second electrode.

10. A cantilever heating mechanism according to claim 9, wherein the holder is equipped with a stationary base and a fixing part, and the cantilever is pushed and held to the stationary base by the fixing part, and a concave placement for holding the cantilever is formed to the stationary base, wherein the first electrode and the second electrode are protruded from inside walls of the concave placement, and wherein the first electrode and the second electrode are arranged nearby the probe tip of the cantilever when the cantilever is pushed and held to the concave placement by the fixing part.

11. A cantilever heating mechanism according to claim 9, wherein the cantilever is made of semiconducting material such as silicon, and further comprising: a third electrode, which is in electric contact with the cantilever by holding the cantilever onto the holder, and a controller, wherein the controller controls the potential of the third electrode with respect to those of the first electrode and the second electrode.

12. A cantilever heating mechanism according to claim 11, wherein the fixing part is conductive material, and wherein the fixing part functions as the third electrode.

13. A cantilever heating mechanism according to claim 11, wherein the controller controls the potentials of the first electrode and the second electrode and/or the controller controls the potential of the third electrode.

14. A cantilever holder used for scanning probe microscopy, comprising the cantilever heating mechanism according to any one of claim 9.

15. A cantilever heating method for heating a cantilever with a tip, comprising steps:
holding the cantilever onto a holder which detachably holds the cantilever; and applying a voltage at least between the first electrode and the second electrode, which are in electric contact with the cantilever by holding the cantilever onto the holder.

16. A cantilever heating method according to claim 15, wherein the cantilever is made of semiconducting material such as silicon, and further comprising steps:
attaching a third electrode to the cantilever, which is in electric contact with the cantilever by holding the cantilever onto the holder; controlling the potential of the third electrode potential with respect to those of the first and the second electrodes by a controller.
